(19) United States
(12) Patent Application Publication
(10) Pub. No.: US 2007/0206847 A1
(43) Pub. Date: Sep. 6, 2007

(54) Correction of vibration-induced and random positioning errors in tomosynthesis

(76) Inventors: John M. Heumann, Loveland, CO (US); David Gines, Ft. Collins, CO (US); Daniel Usikov, Newark, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/369,114

(22) Filed: Mar. 6, 2006

(51) Int. Cl. G06K 9/00; G06K 9/40

(52) U.S. Cl. 382/154; 382/255; 382/131

(57) ABSTRACT

A method and system for correcting positioning errors in a feature projected image set comprising projections of an object under inspection includes identifying at least one region of interest in at least one respective projection from the feature projected image set that substantially corresponds to a corresponding region of interest in a reconstructed image generated based on the feature projected image set, and estimating a respective corrective shift corresponding to the at least one respective projection and applying the respective corrective shift to generate a corresponding at least one corrected respective projection wherein the identified at least one region of interest in the corresponding at least one corrected respective projection is substantially coincident with the corresponding region of interest the reconstructed image. A corrected reconstructed image may then be generated using the at least one corrected respective projection.

### BACKGROUND OF THE INVENTION

Tomographic imaging techniques are often utilized in x-ray inspection systems. “Tomography,” as used here, is a general term describing various techniques for imaging one or more cross-sectional “focal plane(s)” through an object. Tomography typically involves forming projected images (hereinafter “projections”) of a region of interest using some type of penetrating radiation, such as x-rays, sound waves, particle beams, or products of radioactive decay, that are then combined with the application of a reconstruction technique. Tomography has been applied in diverse fields to objects ranging in size from microscopic to astronomical. X-ray tomography, for example, is commonly used to inspect solder joints for defects formed during fabrication of printed circuit assemblies.

In “laminography,” also know as “classical tomography”, two or more of the source, object, and detector are moved in a coordinated fashion during exposure to produce an image of the desired plane on the detector. The motion may be in a variety of patterns including, but not limited to, linear, circular, helical, elliptical, or random. In each case, the motion is coordinated so that the image of the focal plane remains stationary and in sharp focus on the detector, while planes above and below the focal plane move and are blurred into the background. Reconstruction takes place in the detector during exposure and consists simply of integration. Laminography can therefore be considered a form of “dynamic tomography” since motion is typically continuous throughout exposure.

Like laminography, “tomosynthesis” requires coordinated positioning of the source, detector and object. In fact, similar data acquisition geometries may be used in each case. Tomosynthesis differs from laminography in that projections are typically acquired with the motion stopped at multiple, fixed points. Reconstruction is then performed by digitally averaging, or otherwise combining, these projections. Equivalently, projections for tomosynthesis can be acquired with continuous motion using, for example, line sensors as described below. Tomosynthesis can be considered a digital approximation to laminography, or a form of “static tomography,” since the source and detector are typically stationary during acquisition of each projection. However, this dichotomy between dynamic and static tomography is somewhat dated and artificial since numerous hybrid schemes are also possible. Tomosynthesis, which can also be considered a specific form of computed tomography, or “CT,” was first described in D. Grant, “Tomosynthesis: A Three Dimensional) Radiographic Imaging Technique”, IEEE Trans. Biomed. Eng: BME-19: 20-28, (1972), and incorporated by reference here.

In typical laminography, a single, flat focal plane is chosen in advance for imaging during an acquisition cycle. With tomosynthesis, on the other hand, a single set of projections which image a given region of interest of an object under inspection (hereinafter referred to as a “feature projected image set”) may be used repeatedly to reconstruct images of focal planes at varying heights. This “tomosynthetic reconstruction” is typically accomplished by shifting or translating the projections relative to each other prior to combining. Thus, images of the object at varying focal plane heights can be reconstructed from a single feature projected image set.

The projected images that make up a feature projected image set may not be acquired simultaneously. This may occur, for example, as a result of having to reposition two or more of the object under inspection, the x-ray source, and the sensor(s) relative each other in between acquisition of each projection.

During projection acquisition, vibration induced or random positioning errors may be introduced into the positioning of the object under inspection, resulting in vibration and positioning errors in the acquired projections. This can occur, for example, due to system vibrations from previous movement of the transport mechanism of the inspection system while the projection is acquired even though the object is stationary. Other ways this can occur include, by way of example only and not limitation, variation in vertical position of the sensors relative to the focal plane and to one another due to a mechanical positioning error (i.e., allowed tolerances) by the transport system, or variation in the vertical position of the object under inspection relative to the focal plane from one projection acquisition position to another due to a mechanical positioning error (i.e., allowed tolerances) by the transport system.

Vibration induced or random positioning errors in the projections in a given feature projected image set may result in focal plane variation between projections of the feature projected image set (i.e., all projections in the feature projected image set may not be aligned along the same focal plane). When projections in a feature projected image set are not all aligned along the same focal plane, image degradation can occur.

### SUMMARY OF THE INVENTION

Embodiments of the invention include methods, systems and components for correcting random positioning errors in a feature projected image set acquired by an image acquisition system. The feature projected image set is made up of a plurality of projections of a region of interest of an object under inspection.

In one embodiment, a method obtains an initial reconstructed image generated from the feature projected image set, identifies at least one region of interest in at least one respective projection from the feature projected image set that substantially corresponds to a corresponding region of interest in the initial reconstructed image, estimates a respective corrective shift corresponding to the at least one respective projection and applies the respective corrective shift to generate a corresponding at least one corrected respective projection wherein the identified at least one region of interest in the corresponding at least one corrected respective projection is substantially coincident with the corresponding region of interest the reconstructed image.

In one embodiment, the at least one corrected respective projections may then be used to reconstruct a corrected reconstructed image using the at least one corrected respective projection.

In one embodiment, the method is embodied as program instructions on a computer readable storage medium and executable by a computer processor.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective side view of an image acquisition model illustrating the acquisition of projections;

FIG. 2 is a perspective side view of another image acquisition model illustrating the acquisition of projections;

FIG. 3 is a perspective side view of yet another image acquisition model illustrating the acquisition of projections;

FIG. 4 is a flowchart illustrating an exemplary embodiment of a method for correcting random positioning errors in a feature projected image set; and

FIG. 5 is a block diagram illustrating a computer system for performing correction of random positioning errors in a feature projected image set.

### DETAILED DESCRIPTION

For simplicity and illustrative purposes, the principles of the embodiments are described. Moreover, in the following detailed description, references are made to the accompanying figures, which illustrate specific embodiments. Electrical, mechanical, logical, and structural changes may be made to the embodiments without departing from the spirit and scope of the embodiments.

According to an embodiment, a method seeks to correct random positioning errors in a feature projected image set.

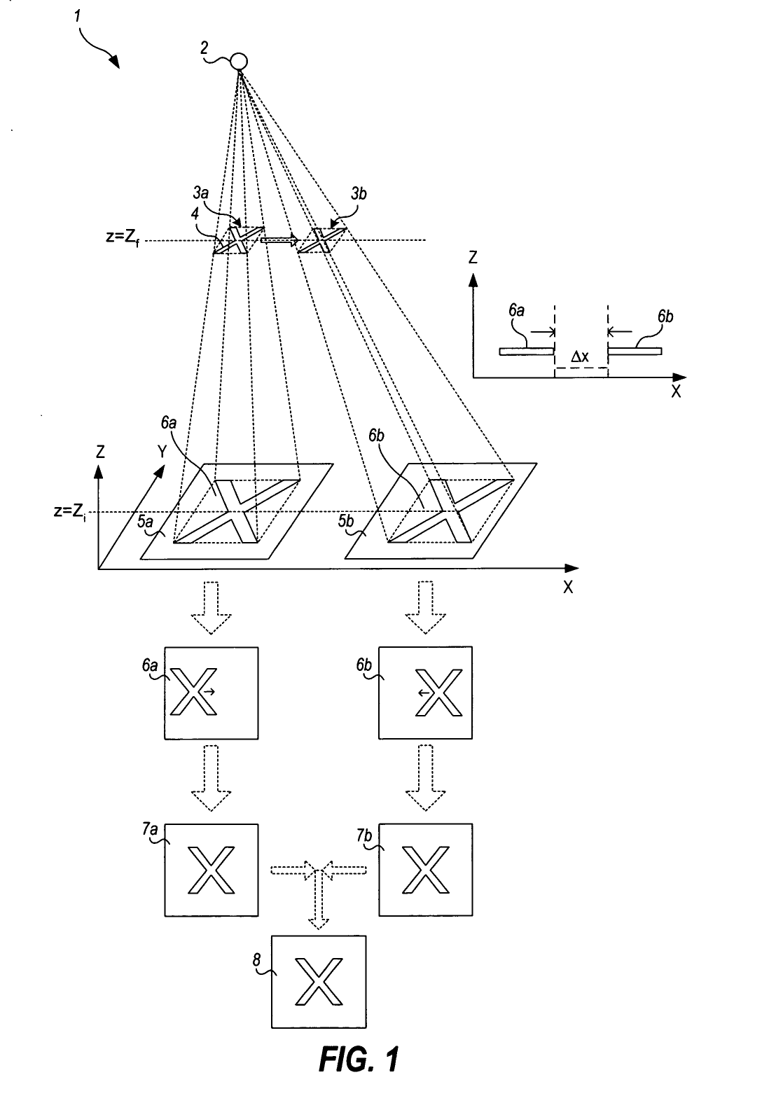

FIG. 1 illustrates a projection acquisition model 1 in which projections 6a, 6b of an object 4 are acquired by sensors 5a, 5b. In FIG. 1, sensors 5a, 5b are aligned along the same imaging plane and the object 4 is moved from a first position 3a, where it becomes stationary during the acquisition of a first projection 6a by the first sensor 5a, to a second position 3b, where it becomes stationary again during the acquisition of a second projection 6b by the second sensor 5b.

During image reconstruction of an image 8 utilizing a set of acquired projections 6a, 6b, the projections 6a, 6b are shifted to seek to make the features in the projections 6a, 6b coincident. The shifted projections 7a, 7b are then are combined, for example by averaging. As shown in FIG. 1, when the position of the object 4 at each of the first position 3a and the second position 3b is aligned along the same focal plane, z=Z_{f}, and the projections 6a, 6b are imaged along the same plane (i.e., the sensors 5a, 5b lie along the same imaging plane, z=Zᵢ), the resulting reconstructed image 8 is sharp and in focus. The term “sharpness” refers to the amount of detail that can be perceived in an image, in terms of resolution (typically measured in terms of the number of distinguishable line pairs per millimeter) and acutance (the power to resolve detail in the transition of edges). As used herein, the term “in focus” refers to the state in which points on the object have a one-to-one mapping to points on an image. If a point on the object maps or spreads into a number points in the image, then the image is out of focus. If the blurring function is shift-invariant, it is called the point spread function. If the mapping is such that the image cannot be uniformly focused with the correct spatial relationship, then it is said to have “aberrations”.

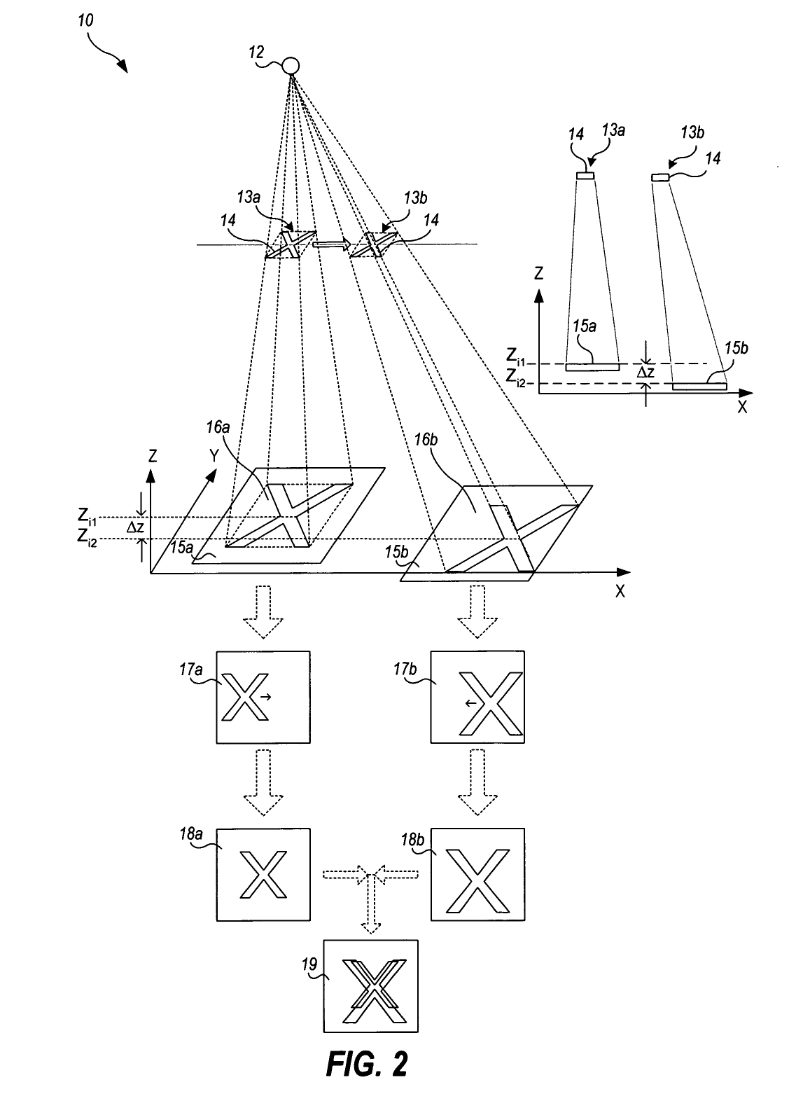

FIG. 2 illustrates a projection acquisition model 10 in which projections 16a, 16b of an object 14 are acquired by sensors 15a, 15b that are misaligned by an amount, Δz, in the imaging plane. In other words, projections 16a and 16b are actually imaged in different imaging planes, z=Zᵢ₁ and z=Zᵢ₂. In FIG. 2, the object 14 is moved from its first position 13a (where it becomes stationary during the acquisition of a first projection 16a by the first sensor 15a) to its second position 13b (where it becomes stationary again during the acquisition of a second projection 16b by the second sensor 15b). During image reconstruction, the projections 16a, 16b may be shifted to seek to make the features in the projection coincident. However, since the imaging plane was not aligned during the acquisition of both projections (i.e., Zᵢ₁≠Zᵢ₂), the magnification of the projected object in the resulting projections 16a, 16b are different from one another. Additionally, the x-y position of the projected object in the resulting projections 16a, 16b are different than they would be if the imaging planes had been aligned (i.e., if Zᵢ₁=Zᵢ₂). Accordingly, no shifting of the projections 16a, 16b in the x-y plane of the respective projections can result in coincidence of all of the object features in both projections 16a, 16b, because the magnification of the object 14 in each projection 16a, 16b is different due to the differences in the imaging plane. The resulting reconstructed image 18 will therefore contain aberrations, resulting in blurriness of the features of the imaged object.

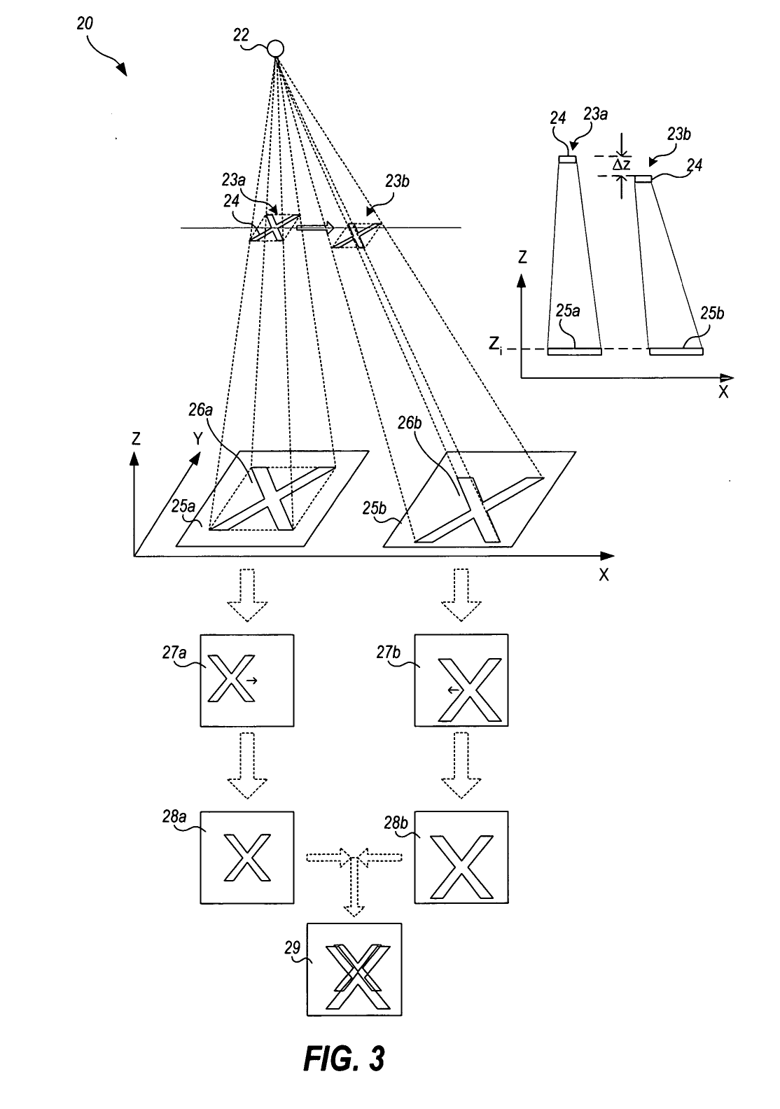

FIG. 3 illustrates a projection acquisition model 20 in which projections 26a, 26b of an object 24 are acquired by sensors 25a, 25b that are in alignment in the imaging plane (i.e., Zᵢ₁=Zᵢ₂=Zᵢ), but when the object 24 is moved from its first position 23a to its second position 23b, its position relative the focal plane changes (i.e., the focal planes, Z_{f1} and Z_{f2}, are different (Z_{f1}≠Z_{f2})). This results in similar problems of magnification and projected object shifts (shown at 27a, 27b), as described with respect to FIG. 2, with the projections 26a, 26b. The resulting reconstructed image 28 will therefore not only be out of focus, but also contain aberrations.

While the acquisition of only two projections is illustrated for purposes of simplicity in each of FIGS. 1, 2, and 3, it is to be understood that there may be, and typically will be, more such projections acquired, each imaging the object under inspection from a different perspective. Furthermore, it is to be understood that the number and type of sensors may differ depending on the technique utilized to obtain a number of projections that belong to a given feature projected image set.

In one embodiment, presented herein by way of example only and not limitation, the projections may alternatively be acquired by a system that utilizes a single large stationary image intensifier or several smaller stationary area image sensors, wherein the system operates to allow the x-ray source to dwell at particular angles through the region of interest of the object while a projection is acquired at each of these angles.

In another embodiment, again presented by way of example only and not limitation, the projections may be acquired by a system that utilizes a plurality of line sensors along with a scan-and-step projection acquisition functionality. The plurality of line sensors may be arranged as a planar array, and may be aligned in parallel. A projection is captured by at least one and, typically, by each line sensor while the object is continuously scanned in a direction across (typically perpendicular to) the sensors to complete what is referred to as a scan pass. After each scan pass, the object is moved a step in a direction different than the scanning direction. In one embodiment, the step direction may be perpendicular to the scanning direction. Projections are not acquired during a step.

The movement of the object, source, and/or sensors by a transport mechanism may result in vibration induced positioning errors in the acquired projections of a given feature projected image set. Vibration induced and other random positioning errors may come in the form of any of the forms illustrated in FIGS. 1, 2 and 3, including shift errors, focal plane misalignment, and aberrations. It will be noted, however, that generally speaking, vibration induced and other random positioning errors will tend to blur the features in a region of interest of an object under inspection, but because in tomosynthesis all projections in a given feature projected image set are averaged, the shifts tend to cancel in the reconstructed image, and therefore the location of the features in the reconstructed image are not greatly altered.

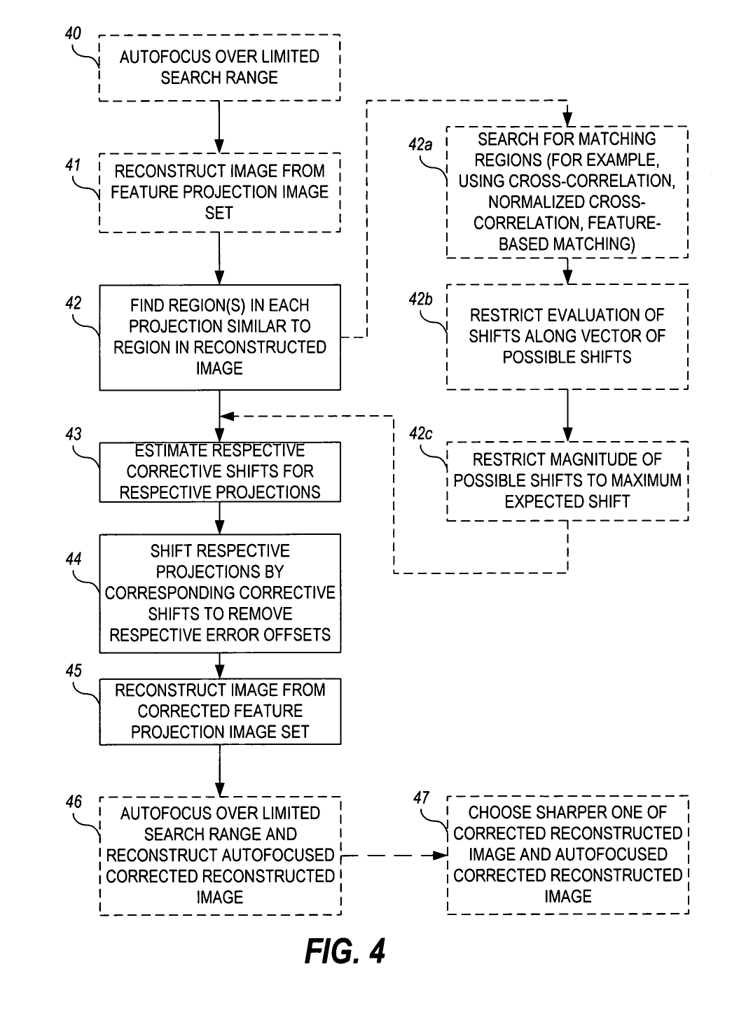

FIG. 4 is a flowchart illustrating an embodiment of a method 40 for correcting positioning errors in a feature projected image set. While the essential elements of the method for correcting positioning errors are indicated using solid lines, optional steps that may be additionally performed to enhance the corrective factor of the algorithm, and/or steps that may be performed independently of (and the results fed to) the method 40 are outlined in FIG. 4 using dashed lines. Assume or generate a feature projected image set (which presumably contains vibration induced or other random positioning errors) that may be optionally (as designated in FIG. 4 by the use of dashed lines) auto-focused (step 40). In one embodiment, a known auto-focus algorithm (such as described in U.S. Pat. App. Pub. No. 20050047636 to Gines et al, entitled “System And Method For Performing Auto-Focused Tomosynthesis” and incorporated by reference herein for all that it teaches) is utilized to select a focal plane Z_{f} (preferably resulting in a sharpest image of the region of interest of the object under inspection) for the projections in the feature projected image set.

Continuing with the method 40, generate or otherwise obtain an initial reconstructed image from the (optionally autofocused) feature projected image set (step 41). For each projection in the feature projected image set, locate at least one region of interest in the respective projection that is similar to a corresponding region of interest in the initial reconstructed image (step 42). To this end, features in a given region of interest of a given projection should substantially match in shape, and preferably size, features in a corresponding region of interest of the reconstructed image. For each projection in the feature projected image set, a corrective shift for the corresponding projection is estimated that would align the identified region of interest in the projection with the corresponding region of interest the reconstructed image (step 43). The corrective shifts are applied to their respective projections to remove the offset in the respective projections generated by vibration-induced or random positioning errors (step 44). A corrected reconstructed image is reconstructed using the corrected projections in the corrected feature projected image set (step 45). The auto-focusing algorithm may be repeated on the corrected feature projected image set over a limited search range after the offsets have been corrected and an autofocused corrected reconstructed image reconstructed from the corrected feature projected image set (step 46). The sharper image of the corrected reconstructed image (computed in step 45) and the autofocused corrected reconstructed image (computed in step 46) is preferably chosen as the final reconstructed image (step 47).

The primary effect of a vertical shift (z-axis) in object location is a shift in image position in a known direction, namely the projection onto the sensor of the vector connecting the source and the center of the sensor. The major effect of vibration is blurring of reconstructed images without shifting the location of features in the reconstruction. Features are shifted in individual projections, but because a multitude of projections are averaged in shift-and-add tomosynthesis, the shifts tend to cancel in the reconstructed image. As a result, one can look in each projection for the regions most similar to the reconstructed image in order to estimate the shift for each projection. Cross-correlation and, preferably, normalized cross-correlation are examples of appropriate measures for region matching (step 42a). Alternative measures, such as feature-based matching may also be used. Where cross-correlation is used, full 2-dimensional cross-correlation may be computed. However, if the directions in which any shifts are likely to occur are known in advance, it may not necessary to compute the full 2-dimensional cross-correlation. Thus, in one embodiment, the evaluation of the cross-correlation may be performed only along the line of possible shifts (step 42b). Additionally, the magnitude of the shifts may be restricted according to the maximum shift expected (step 42c).

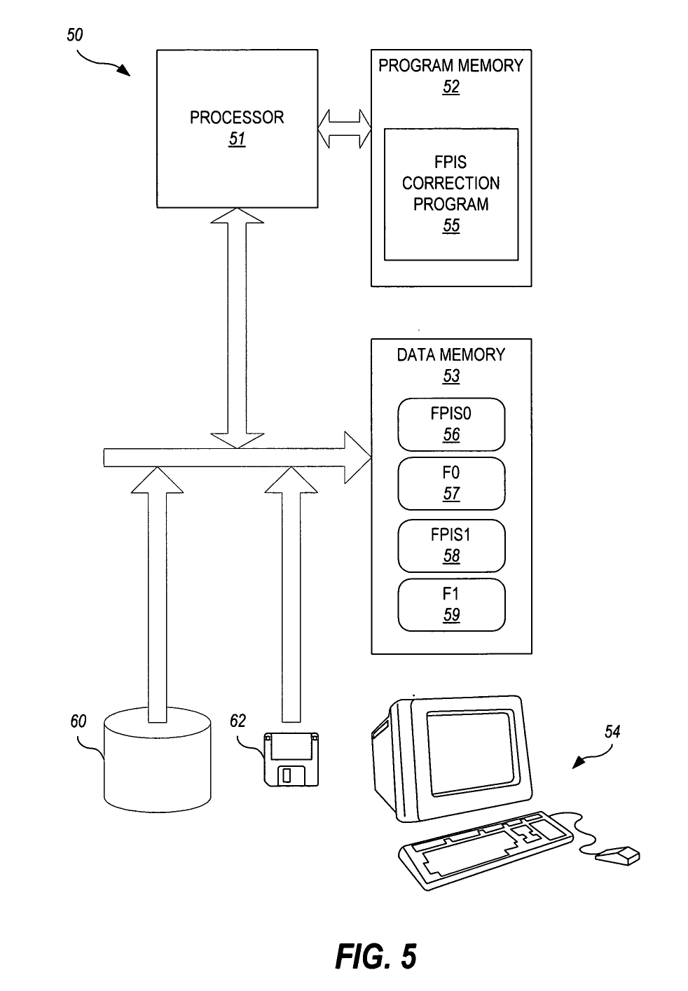

FIG. 5 is a computer system 50 that performs image correction. The computer system 50 includes a processor 51, program memory 52, data memory 53, and input/output means 54 (for example, including a keyboard, a mouse, a display monitor, external memory readers, etc.) in accordance with well-known computer systems. A program 55 comprising program instructions executable by the processor 51 that implements a positioning error correction algorithm may be stored in the program memory 52 or read from a computer readable storage medium (such as an external disk 60, or floppy disk 61) accessible by the computer system 50. The computer system 50 receives or generates a feature projected image set comprising acquired projections of a region of interest of an object under inspection. The computer system 50 receives or generates a reconstructed image of the region of interest of the object under inspection based on the feature projected image set. The feature projected image set and reconstructed image may be stored in the data memory 53 or on a computer readable storage medium 60, 61 accessible by the computer system 50.

The processor 51 may execute the program instructions of the program 55 to generate a corrected feature projected image set and/or a corrected reconstructed image.

In one embodiment, vibration correction of the feature projected image set may be performed in the image domain. In this embodiment, an auto-focus algorithm may be performed on the feature projected image set containing the region of interest to maximize sharpness, s. The region of interest should be chosen small enough that vibration-induced distortion within the region of interest is not significant. The reconstructed, auto-focused image may be denoted as f₀, and its sharpness as s₀. In this embodiment, for each projected image, Pᵢ, i=1 . . . n, the following steps may be performed:
a. Compute Cᵢ, the normalized cross-correlation between f₀ and Pᵢ. Although cross-correlation is a two-dimensional function, only the values of Cᵢ along a 1-dimensional line through the origin in the direction in which changes in z will cause Pᵢ to shift are required. Let vᵢ be a unit vector in this direction. Additionally, the maximum distance from the origin is given by the maximum vibration-induced shift in pixels.
b. Let χᵢ(d) denote the value of Cᵢ along this line as a function of the 1-dimensional signed distance from the origin.
c. Let dᵢ=arg max χᵢ(d). The, dᵢ is an estimate of vᵢ offset for projection Pᵢ.

The magnification will typically be known as a function of dᵢ (e.g., from previous calibration or system geometry. Individual projections may therefore be corrected at this point for changes in relative magnification, if desired. Sinc interpolation, such as that described in L. P. Yaroslavsky, “Signal Sinc-Interpolation: A Fast Computer Algorithm,” Bioimaging, 4: 225-231, 1996, is an appropriate technique for performing these corrections. This correction may be omitted when vibration-induced changes in magnification are negligible, as is often the case in automated x-ray inspection.

A corrected reconstructed image, f₁, of the reconstructed region of interest is generated using shift-and-add tomosynthesis, but with each projection, Pᵢ, shifted by a distance −dᵢ along vᵢ. This is a first-order vibration corrected reconstruction. Steps a through c may be repeated using the corrected reconstructed image generated at the end of each pass as input until convergence if desired. In practice, a single pass has proved sufficient.

Because the relative positions of projections may have been changed during each pass, the auto-focus algorithm may be repeated for a search for sharpest focus within a limited range around f₁. The maximum shift to be considered is the largest vibration induced horizontal pixel shift expected. Starting with the projection offsets dᵢ from step c, the auto-focus algorithm may be repeated over this limited search range. Denote the autofocused corrected reconstructed image so obtained as f₂ and its sharpness as s₂. If (s₂>s₁) return f₂ as the vibration corrected image; otherwise return f₁.

A script in a meta language for programming the computer system 50 according to an embodiment may include the following:

get_fpis(FPIS0);
initialize(FPIS1,FPIS0);
autofocus(FPIS0, Z0, S0);
Reconstruct(F0, FPIS0, Z0);
FOR(i = 1..n)

Pi = get_projection(i, FPIS0)
compute_cc(Ci, Pi0, F0);
correct(Ci, Pi0, FPIS0, Pi1, FPIS1);

END_FOR;
reconstruct(F1, FPIS1, Z0);
autofocus(FPIS1, Z1, S1);
reconstruct(F2, FPIS1, Z1);

where
FPIS0=initial feature projected image set;
F0=initial reconstructed image;
FPIS1=corrected feature projected image set;
F1=corrected reconstructed image;
Pi0=projection i;
Ci=normalized cross-correlation between projection i and reconstructed image;
F2=corrected autofocused reconstructed image;
Z0=focal plane resulting from autofocus of initial feature projected image set;
S0=sharpness of autofocused initial feature projected image set;
Z1=focal plane resulting from autofocus of corrected feature projected image set;
S1=sharpness of autofocused corrected feature projected image;

and where
get_fpis(fpis)=function that returns a feature projected image set in variable fpis;
initialize(fpis1, fpis0)=function that creates and initializes a feature projected image set, fpis1, of the same size as feature projected image set, fpis0;
autofocus(fpis, z, s)=function that performs autofocus on feature projected image set, fpis, and returns focal plane, z, and sharpness, s, of image at z;
reconstruct(f, fpis, z)=function that generates reconstructed image, f, given a feature projected image set, fpis and desired focal plane, z;
get_projection(i, fpis)=function that gets projection Pi, from feature projected image set, fpis; returns NULL if there is no projection Pi;
compute_cc(c, p, f)=function that computes the normalized cross-correlation, c, between a projection, p, and a reconstructed image, f; and
correct(c, p0, fpis0, p1, fpis1)=function that performs a corrective shift on projection, p0, from feature projected image set, fpis0, to offset the amount of normalized cross-correlation, c, and placing the corrected (shifted) projection into projection p1 in feature projected image set, fpis1.

In another embodiment, vibration correction of the feature projected image set may be performed in the transform domain. For example, in this embodiment, a multi-resolution image pyramid such as a discrete wavelet transform (DWT) with a shift-invariant basis may be used. As in the image domain embodiment discussed above, an auto-focus algorithm may be performed on the feature projected image set containing the region of interest to maximize sharpness, s. The region of interest should be chosen small enough that vibration-induced distortion within the region of interest is not significant. In one embodiment, the autofocus algorithm is implemented as described in U.S. Pat. App. Pub. No. 20050047636, supra.

The reconstructed, auto-focused image may be denoted as f₀, and its sharpness as s₀. In this embodiment, for each projected image, Pᵢ, i=1 . . . n, the following steps may be performed:

i. Choose a coarse scale to begin the computations. For example, suppose the maximum possible shift at the original image resolution is D pixels. Denote the original resolution as scale 0, with resolution decreasing by a factor of 2 at each scale. Choose k as the smallest integer such that 2^{k}>D, and begin computation at scale k.

ii. Auto-focus a region of interest in the feature projected image set using the variance of a norm of the detail coefficients of the wavelet transform to measure of sharpness, for example, the variance of an L1-norm (sum of absolute values) or L2-norm (mean-square norm)

iii. Compute shift offsets at this scale using a maximum shift of two pixels. (Recall that each pixel on a coarse scale corresponds to more than one pixel at finer scales.)

iv. Using the current estimate of the sharpest layer from step ii, and the current estimate of the shift offsets from step iii, continue with step ii at the next finer scale, with starting values centered around current estimates. The auto-focus search can now also be conducted over a limited range (maximum shifts of ±˜2 pixels).

v. Terminate the algorithm after operations have been completed at the desired resolution.

In performing autofocusing, a projection is processed by a wavelet transform such as the well-known 2D Haar wavelet transform. The wavelet transform transforms the projection into a representation of the projection at multiple different resolutions. For example, the wavelet transform transforms a projection into a low-pass filtered residual and high-pass filtered projections at a plurality of different resolutions, such as a low-resolution high-pass filtered projection, a higher-resolution high-pass filtered projection, and an even higher-resolution high-pass filtered projection. For example, a low-resolution high-pass filtered projection may be one-eighth (⅛) the resolution of the corresponding original projection; a higher-resolution high-pass filtered projection may be one-fourth (¼) the resolution of the corresponding original projection; and an even higher-resolution high-pass filtered projection may be one-half (½) the resolution of the corresponding original projection. As described in U.S. Pat. App. Pub. No. 20050047636, gradient-based measures of sharpness may be derived from the high-pass filtered projections. In this manner, the result of processing projection with a wavelet transform provides gradient-based information in a hierarchy of resolutions. The hierarchy of resolutions of gradient-based image data to perform the auto-focusing operation.

The algorithm for performing vibration correction in the transform domain differs from the algorithm for performing vibration correction in the image domain in that a) alternate sharpness measures may be used (e.g., the variance of an L1 or L2 norm of the detail coefficients of discrete wavelet transform coefficients in a Haar basis, and b) location of the maximum cross-correlation proceeds up the resolution pyramid from the coarsest to the finest scale, and c) each shift is scaled down proportionally at successively coarser scales. In the case of a discrete wavelet transform pyramid using a Haar basis, all operations may be performed in the transform space (i.e., there is no need to convert back to the original image space until the final image is required.

The advantage of this approach is that many, if not all, of the computations can be done on coarser levels or scales, which have fewer pixels. Additionally, fewer shifts are required at each level in the cross-correlation computation, since values from previous (coarser) scale provide good starting values. In the approach outlined above, shifts have been restricted to two pixels at each scale. Preliminary research has shown that this type of multilevel approach may be used successfully for problems related to image sharpness and focusing.

Note that interpolation is possible to locate maximum normalized cross-correlations and perform vibration correction with sub-pixel accuracy.

Above described embodiments show that vibration-induced or other system component positioning error shifts can be identified between individual projections and an initial reconstructed image, corrected, and a more accurate reconstructed image obtained. Additional knowledge concerning the source of the error, for example in the case of vibration-induced errors or where the geometry of the system is known, cross-correlation may only need to be computed along pre-defined directions and utilizing a maximum possible shift, which provides sizable reductions in computational complexity. Additional optimization may be achieved in the form of a multi-resolution pyramid based on the discrete wavelet transform.

Those of skill in the art will appreciate that the invented method and apparatus described and illustrated herein may be implemented in software, firmware or hardware, or any suitable combination thereof.

In one embodiment, the technique is applied in the inspection of solder joints of a printed circuit board (PCB) on a feature projected image set that have random positioning errors.

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method for correcting positioning errors in a feature projected image set comprising a plurality of projections of a region of interest of an object under inspection, the method comprising:
obtaining an initial reconstructed image generated from the feature projected image set;
identifying at least one region of interest in at least one respective projection from the feature projected image set that substantially corresponds to a corresponding region of interest in the initial reconstructed image; and
estimating a respective corrective shift corresponding to the at least one respective projection and applying the respective corrective shift to generate a corresponding at least one corrected respective projection wherein the identified at least one region of interest in the corresponding at least one corrected respective projection is substantially coincident with the corresponding region of interest the reconstructed image.

2. The method of claim 1, further comprising:
reconstructing a corrected reconstructed image using the at least one corrected respective projection.

3. The method of claim 2, wherein the reconstructing step is performed using tomosynthesis.

4. The method of claim 1, further comprising:
applying an auto-focus algorithm to the feature projected image set prior to or while generating the initial reconstructed image.

5. The method of claim 4, further comprising
generating a corrected feature projected image set, the corrected feature projected image set comprising the feature projected image set that replaces the at least one respective projection with the at least one corrected respective projection;
applying an auto-focus algorithm to the corrected feature projected image set; and
reconstructing an auto-focused corrected reconstructed image using the auto-focused corrected feature projected image set.

6. The method of claim 5, wherein at least one of the reconstructing steps is performed using tomosynthesis.

7. The method of claim 1, wherein the step of identifying at least one region of interest in at least one respective projection from the feature projected image set that substantially corresponds to a corresponding region of interest in the initial reconstructed image comprises computing a cross-correlation between the at least one region of interest in the at least one respective projection and the corresponding region of interest in the initial reconstructed image.

8. The method of claim 7, wherein the step of computing the cross-correlation comprising evaluating the cross-correlation along two dimensions.

9. The method of claim 7, wherein the step of computing the cross-correlation comprises evaluating the cross-correlation only along a vector of possible shifts.

10. The method of claim 9, wherein a magnitude of the possible shifts is restricted based on a maximum vibration expected.

11. A method in accordance with claim 7, wherein the cross-correlation is performed in a transform domain.

12. A method in accordance with claim 7, wherein the cross-correlation comprises the application of a wavelet transform to the at least one respective projection.

13. A method in accordance with claim 7, wherein the cross-correlation is performed in an image domain.

14. A method in accordance with claim 1, wherein:
the identifying step and the estimating step are performed for each projection in the feature projected image set.

15. A computer readable storage medium tangibly embodying program instructions implementing a method for correcting positioning errors in a feature projected image set comprising a plurality of projections of a region of interest of an object under inspection, the method comprising:
obtaining an initial reconstructed image generated from the feature projected image set;
identifying at least one region of interest in at least one respective projection from the feature projected image set that substantially corresponds to a corresponding region of interest in the initial reconstructed image; and
estimating a respective corrective shift corresponding to the at least one respective projection and applying the respective corrective shift to generate a corresponding at least one corrected respective projection wherein the identified at least one region of interest in the corresponding at least one corrected respective projection is substantially coincident with the corresponding region of interest the reconstructed image.

16. The computer readable storage medium of claim 15, the method further comprising:
reconstructing a corrected reconstructed image using the at least one corrected respective projection.

17. The computer readable storage medium of claim 16, wherein the reconstructing step is performed using tomosynthesis.

18. The computer readable storage medium of claim 15, further comprising:
applying an auto-focus algorithm to the feature projected image set prior to or while generating the initial reconstructed image.

19. The computer readable storage medium of claim 18, the method further comprising
generating a corrected feature projected image set, the corrected feature projected image set comprising the feature projected image set that replaces the at least one respective projection with the at least one corrected respective projection;
applying an auto-focus algorithm to the corrected feature projected image set; and
reconstructing an auto-focused corrected reconstructed image using the auto-focused corrected feature projected image set.

20. The computer readable storage medium of claim 19, wherein at least one of the reconstructing steps is performed using tomosynthesis.

21. The computer readable storage medium of claim 18, wherein the step of identifying at least one region of interest in at least one respective projection from the feature projected image set that substantially corresponds to a corresponding region of interest in the initial reconstructed image comprises computing a cross-correlation between the at least one region of interest in the at least one respective projection and the corresponding region of interest in the initial reconstructed image.

22. The computer readable storage medium of claim 21, wherein the step of computing the cross-correlation comprising evaluating the cross-correlation along two dimensions.

23. The computer readable storage medium of claim 21, wherein the step of computing the cross-correlation comprises evaluating the cross-correlation only along a vector of possible shifts.

24. The computer readable storage medium of claim 23, wherein a magnitude of the possible shifts is restricted based on a maximum vibration expected.

25. The computer readable storage medium of claim 21, wherein the cross-correlation is performed in a transform domain.

26. The computer readable storage medium of claim 21, wherein the cross-correlation comprises the application of a wavelet transform to the at least one respective projection.

27. The computer readable storage medium of claim 21, wherein the cross-correlation is performed in an image domain.

28. The computer readable storage medium of claim 15, wherein:
the identifying step and the estimating step are performed for each projection in the feature projected image set.

29. A system comprising:
a matching function which identifies at least one region of interest in at least one respective projection from a feature projected image set that substantially corresponds to a corresponding region of interest in an initial reconstructed image generated from the feature projected image set; and
a feature projected image set correction function which estimates a respective corrective shift corresponding to the at least one respective projection and applies the respective corrective shift to generate a corresponding at least one corrected respective projection wherein the identified at least one region of interest in the corresponding at least one corrected respective projection is substantially coincident with the corresponding region of interest the initial reconstructed image.

30. The system of claim 29, further comprising:
an image reconstruction function which reconstructs a corrected reconstructed image using the at least one corrected respective projection.

31. The system of claim 29, further comprising:
an auto-focus function which performs autofocusing on the feature projected image set prior to or while generating the initial reconstructed image.

32. The system of claim 29, further comprising:
an auto-focus function which performs autofocusing on a corrected feature projected image set, the corrected feature projected image set comprising the feature projected image set that replaces the at least one respective projection with the at least one corrected respective projection.

33. The system of claim 32, further comprising
an image reconstruction function which reconstructs a corrected reconstructed image using the at least one corrected respective projection.

34. The system of claim 29, wherein the matching function comprises computing a cross-correlation between the at least one region of interest in the at least one respective projection and the corresponding region of interest in the initial reconstructed image.

35. The system of claim 34, wherein the matching function comprises evaluating the cross-correlation only along a vector of possible shifts.

36. The system of claim 35, wherein a magnitude of the possible shifts is restricted based on a maximum vibration expected.

37. The system of claim 34, wherein the matching function computes the cross-correlation in a transform domain.

38. The system of claim 34, wherein the matching function applies a wavelet transform to the at least one respective projection.

39. The system of claim 34, wherein the matching function computes the cross-correlation in an image domain.
